(19) United States
(12) Patent Application Publication
(10) Pub. No.: US 2026/0135232 A1
(43) Pub. Date: May 14, 2026

(54) Battery Pack Having Configurable Cells

(71) Applicant: Zebra Technologies Corporation, Lincolnshire, IL (US)

(72) Inventors: Timothy Vermilyea, Lincoln, RI (US); Anthony Ross Helberg, Attleboro, MA (US)

(21) Appl. No.: 18/942,163

(22) Filed: Nov. 8, 2024

(51) Int. Cl. H01M 50/269; B41J 2/325; B41J 29/393; H01M 10/42; H01M 50/213; H01M 50/247; H01M 50/51; H01M 50/512; H02J 7/00

(52) U.S. Cl. CPC H01M 50/269; B41J 2/325; B41J 29/393; H01M 10/425; H01M 50/213; H01M 50/247; H01M 50/51; H01M 50/512; H02J 7/56; H01M 2220/30

(57) ABSTRACT

An apparatus includes a plurality of battery cells, a controller, and a cell selector disposed within a housing. The cell selector is operatively coupled to the battery cells and the controller and is operable to configure the battery cells according to a selected cell arrangement from a plurality of possible cell arrangements.

### BACKGROUND

Battery packs can be used to power electronic devices. Such battery packs may be rechargeable via electronic devices. In some instances, different electronic devices can be specified to operate according to different power requirements, which requires that the battery packs satisfy the different power requirements for the electronic devices to operate properly.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of an example media processing device operatively coupled to a battery pack in accordance with embodiments of the present disclosure.

FIG. 2A is a schematic view of an example battery charger operatively coupled to a battery pack in accordance with embodiments of the present disclosure.

FIG. 2B is a schematic view of an example battery charger operatively coupled to an electronic device including a battery pack in accordance with embodiments of the present disclosure.

FIG. 3 illustrates circuitry of an example battery pack in accordance with embodiments of the present disclosure.

FIG. 4A illustrates a simplified view of the circuitry of the example smart battery pack of FIG. 3 to illustrate a configuration of battery cells based on a control signal in accordance with embodiments of the present disclosure.

FIG. 4B illustrates a simplified view of the circuitry of the example smart battery pack of FIG. 3 to illustrate another configuration of the battery cells based on a different control signal in accordance with embodiments of the present disclosure.

FIG. 5 is an example timing diagram illustrating a switching sequence/scheme in accordance with embodiments of the present disclosure.

FIG. 6 illustrates a perspective view of an example battery pack shown in cross-section in accordance with embodiments of the present disclosure.

FIG. 7 illustrates a perspective view of an example battery pack shown in cross-section in accordance with embodiments of the present disclosure.

FIG. 8 illustrates an example battery receiving area of a device shown in cross-section in accordance with embodiments of the present disclosure.

FIG. 9 illustrates a perspective view the example battery pack of FIGS. 6-7 supported by the battery compartment of FIG. 8 shown in cross-section in accordance with embodiments of the present disclosure.

FIG. 10 illustrates a side profile view the example battery pack of FIGS. 6-7 supported by the battery compartment of FIG. 8 shown in cross-section in accordance with embodiments of the present disclosure.

FIG. 11 illustrates another example battery receiving area of a device shown in cross-section in accordance with embodiments of the present disclosure.

FIG. 12 illustrates the example battery pack of FIGS. 6-7 supported by the battery compartment of FIG. 11 shown in cross-section in accordance with embodiments of the present disclosure.

FIG. 13 illustrates an example battery pack including a non-contact switch for generating a control signal to configure battery cells according to cell arrangements in accordance with embodiments of the present disclosure.

FIG. 14 illustrates an example system in accordance with embodiments of the present disclosure.

FIG. 15 is a flowchart illustrating an example process of selecting battery cells in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The media processing devices and other electronic devices can be powered by battery packs that include battery cells that output power to the media processing device and other electronic devices. The media processing devices and/or other electronic devices can have different power requirements typically requiring specific battery packs to be used by the media processing devices and other electronic devices. To accommodate these different power requirements and ensure compatibility across different media processing devices and/or other electronic devices, embodiments of the present disclosure provide a battery pack that includes battery cells connected together by a cell selector that can be controlled to reconfigured an arrangement of the battery cells based on the media processing devices and/or other electronic devices to which the battery pack is connected.

As one non-limiting example, a deployed system can include battery chargers and media processing devices, where the battery chargers are specified to charge battery packs at a specified charging voltage (e.g., eight volts) and at least some of the media processing devices are specified to require an output voltage (e.g., sixteen volts) from the battery pack that is different than the charging voltage. The cell selector of embodiments of the present disclosure can configure the battery cells according to a charging cell arrangement when the battery pack is connected to the battery charger to allow the charger to charger the battery pack using the charging voltage and can configure the battery cells according to a power cell arrangement when the battery pack is connected to the media processing device so that a charged battery pack outputs the required output voltage to the media processing device.

As another example, different electronic devices can require different output voltages from the battery pack and the cell selector can configure the battery cells according to which of the electronic devices the battery pack is connected so that the charged battery pack outputs the appropriate output voltage for the particular electronic device connected with the battery pack.

Example media processing devices of the present disclosure can process (e.g., print, encode, etc.) media by drawing the media from the media source and routing the media proximate various processing components (e.g., printhead, RFID reader/encoder, magnetic stripe reader/encoder etc.). Processing the media from the media source may facilitate a continuous or batch printing process. As an example, embodiments of media processing devices of the present disclosure can be configured to print and/or encode media drawn from a media source, such as roll, spool, or fanfold. Such media can include a continuous web such as a spool of liner-back media or linerless media. In some embodiments, the media can include individual labels disposed on a continuous liner web. In some embodiments, media can be linerless. For thermal transfer printing, the printable surface of the media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media.

The media is routed along a feed path from the media supply to a print position located adjacent to the printhead (e.g., a thermal printhead). The media can be pulled through the feed path by a platen roller driven by a motor, where an operation of the motor is controlled by a processing device. The printhead is generally configured to form a nip with the platen roller to pinch the media between the printhead and the platen roller. This pinching or compressive force provides adequate print quality, and in some applications, ensures that a sufficient tension is maintained the continuous web. Once printed via the printhead, the printed portion of the media is advanced outwardly from the printer through a media outlet by the platen roller where it can be peeled from the liner, cut, and/or torn to separate the printed media from the media supply.

In accordance with embodiments of the present disclosure, an apparatus is disclosed. The apparatus includes a housing, a controller, and a cell selector disposed within the housing. The cell selector is operatively coupled to the battery cells and the controller, the cell selector is operable to configure the battery cells according to a selected cell arrangement from a plurality of possible cell arrangements.

In accordance with embodiments of the present disclosure, a system is disclosed. The system includes an electronic device and a battery pack. The electronic device includes a battery receiving area. The battery pack is configured to be received by the electronic device via the battery receiving area. The battery pack includes a housing containing a plurality of battery cells and a cell selector that configures the plurality of battery cells according to a first cell arrangement in which the battery pack has a first output voltage or a second cell arrangement in which the battery pack has a second output voltage. The cell selector is configured to arrange the battery cells according to the first cell arrangement prior to the battery pack being received by the electronic device via the battery receiving area. Upon receipt of the battery pack by the electronic device via the battery receiving area, the housing of the battery pack causes the cell selector to switch from the first cell arrangement to the second cell arrangement. In one example, the electronic device is at least one of a printer or a battery charger. In one example, the electronic device is the printer and the system includes a battery charger. Upon receipt of the battery pack by the battery charger via the battery receiving area, the housing of the battery pack causes the cell selector to remain in the first cell arrangement.

In accordance with embodiments of the present disclosure, a method is disclosed. The method includes configuring, by a cell selector of a battery pack, a plurality of battery cells of the battery pack according to a first cell arrangement in which the battery pack has a first output voltage. The battery pack includes a housing containing the plurality of battery cells and the cell selector. The method also includes receiving the battery pack via a battery receiving area of an electronic device and switching, by the cell selector, from the first cell arrangement to the second cell arrangement in which the battery pack outputs a second voltage. The housing of the battery pack causes the cell selector to switch to the second cell arrangement upon receipt of the battery pack by the electronic device via the battery receiving area.

In accordance with embodiments of the present disclosure, the cell selector includes a control switch that outputs a control signal based on a state of the control switch, the cell selector selects the selected cell arrangement based on the control signal.

In accordance with embodiments of the present disclosure, the control signal is switchable between ground and an output voltage line, the selected cell arrangement corresponding to a first cell arrangement when the control signal is ground and corresponding to a second cell arrangement when the control signal is an output voltage on the output voltage line.

In accordance with embodiments of the present disclosure, the cell selector includes a plurality of switches that are responsive to the control signal to configure the plurality of cells in the selected cell arrangement.

In accordance with embodiments of the present disclosure, the cell selector includes timing compensation circuitry to control a sequence in which states of the plurality of the switches change in response to the control signal.

In accordance with embodiments of the present disclosure, the timing compensation circuitry introduces timing delays to the control signal to control the sequence.

In accordance with embodiments of the present disclosure, the control switch is an electro-mechanical switch and the housing includes a resilient member that operatively engages the control switch in response to being depressed.

In accordance with embodiments of the present disclosure, the resilient member is integrally formed with the housing by a cantilevered portion of the housing.

In accordance with embodiments of the present disclosure, an arm extends from the resilient member into an interior of the housing and the arm is configured to selectively engage the control switch based on an actuation state of the resilient member.

In accordance with embodiments of the present disclosure, the resilient member is flush with the housing and includes a portion extending away from the housing from a terminal end of the resilient member. The button portion is configured to engage a portion of a device housing of a device when the battery is received by the device housing or to be spaced away from the device housing when the battery is received by the device housing such that the state of the control switch is controlled based on the device that receives the housing

In accordance with embodiments of the present disclosure, the cell selector comprises a plurality of switch devices that are responsive to the state of the control switch.

In accordance with embodiments of the present disclosure, in response to a change in the state of the control switch, a first subset of the plurality of switch device switch to an open state and a second subset of the plurality of switch devices switch to a closed state.

In accordance with embodiments of the present disclosure, the cell selector includes timing compensation circuitry that controls a sequence in which at least a subset of the plurality of switch device switch from a first state to a second state.

In accordance with embodiments of the present disclosure, the cell selector includes circuitry that comprises a first leg. The first leg includes a first battery cell, a second battery cell, and a first transistor. A negative terminal of the first battery cell is coupled to ground and a positive terminal of the first battery cell is coupled to a negative terminal of the second battery cell. A positive terminal of the second battery cell is coupled to a drain of the first transitory and a source of the first transistor is coupled to an output voltage line.

In accordance with embodiments of the present disclosure, the circuitry of the cell selector includes a second leg. The second leg includes a second transistor and a third transistor. A source of the second transistor is coupled to the ground and a drain of the second transistor is coupled to a gate of the first transistor and to a drain of the third transistor. A source of the third transistor is coupled to the output voltage line. A gate of the second transistor and a gate of the third transistor are operatively coupled to the control switch.

In accordance with embodiments of the present disclosure, the circuitry of the cell selector includes a third leg. The third leg includes a fourth transistor, a third battery cell, and a fourth battery cell. A source of the fourth transistor is coupled to the ground and a drain of the fourth transistor is coupled to a negative terminal of the third battery cell. A gate of the fourth transistor is operatively coupled to the control switch. A positive terminal of the third battery cell is coupled to a negative terminal of the fourth battery cell and a positive terminal of the fourth battery terminal is coupled to the output voltage line. A drain of the fourth transistor is also coupled to a drain of a fifth transistor and a source of the fifth transistor is coupled to a first node between the drain of the first transistor and the positive terminal of the second battery cell. A second node between the positive terminal of the first battery cell and the negative terminal of the second battery cell is coupled to the controller.

In accordance with embodiments of the present disclosure, the circuitry of the cell selector includes a fourth leg. The fourth leg, the fourth leg includes a sixth transistor and a seventh transistor. A source of the sixth transistor is coupled to the ground and a drain of the sixth transistor is coupled to the gates of an eighth transistor and a ninth transistor and to the drain of the sixth transistor. A source of the seventh transistor is coupled to the output voltage line. A gate of the sixth transistor and a gate of the seventh transistor are operatively coupled to the control switch. A source of the eighth transistor is coupled to a third node between the positive terminal of the third battery cell and the negative terminal of the fourth battery cell and is also coupled to a drain of a tenth transistor. A gate of the tenth transistor is operatively coupled to the control switch and a source of the tenth transistor is coupled to the controller. A source of the eighth transistor is coupled to the third node between the positive terminal of the third battery cell and the negative terminal of the fourth battery cell and is also coupled to the drain of the tenth transistor. A drain of the tenth transistor is coupled to the drain of the ninth transistor and to the controller. A source of the ninth transistor is coupled to the output voltage line and the output voltage line is also coupled to the controller.

In accordance with embodiments of the present disclosure, the selected cell arrangement configures the plurality of battery cells in a series circuit with each other.

In accordance with embodiments of the present disclosure, the selected cell arrangement configures at least two of the plurality of battery cells in a parallel circuit with each other.

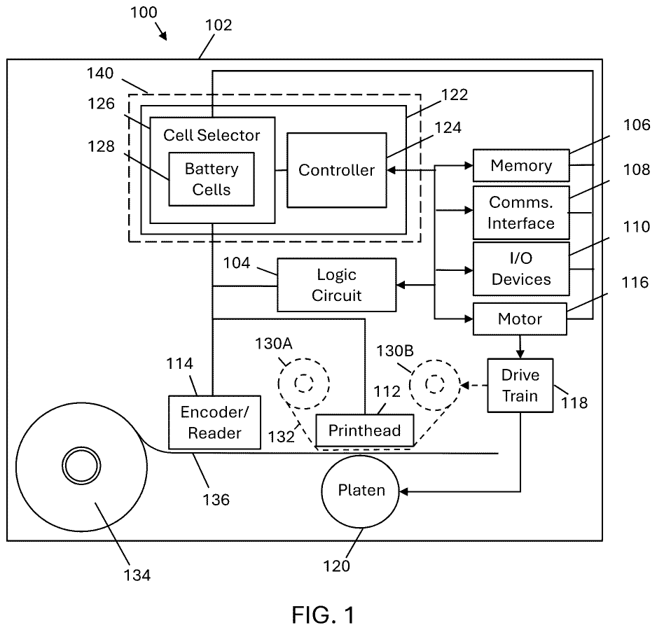

FIG. 1 illustrates a block diagram of an example media processing device 100, such as a printer (e.g., a mobile thermal printer), in accordance with embodiments of the present disclosure. The media processing device 100 can include a housing 102. The housing 102 contains or supports one or more components of the media processing device 100 including, for example, a logic circuit 104, memory 106, a communication interface 108 (e.g., for wired and wireless communication), input/output (I/O) devices 110 (e.g., a display, switches, buttons, speakers, microphone, etc.), a printhead 112, a radiofrequency encoder/reader 114, a motor 116, a drive train 118, a platen roller 120, and a battery pack 122 having a controller 124 and a cell selector circuit 126 that includes battery cells 128. The housing 102 can include one or one housing components and can define one or more compartments within the housing 102. As an example, the housing 102 can define a battery receiving area in the form of a battery compartment or well 140 (or more generally a battery receiving area 140) configured to receive and support the battery pack 122 and to provide an electrical interface to electrically couple the battery to one or more of the electronic components in the housing 102.

The printhead 112 and the platen roller 120 can form a nip. In some embodiments, e.g., for thermal transfer printing, the media processing device 100 can include a ribbon supply spindle 130A and a ribbon take up spindle 130B for supporting an ink ribbon 132. For direct thermal embodiments, the media processing device 100 can be devoid of the ribbon supply spindle 130A, the ribbon take-up spindle 130B, and the ink ribbon 132. The housing 102 can also be configured to contain a media supply 134. As an example, the housing 102 can include a media chamber to store the media supply 134 as it is consumed by the media processing device 100. The logic circuit 104 can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 106 is a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device).

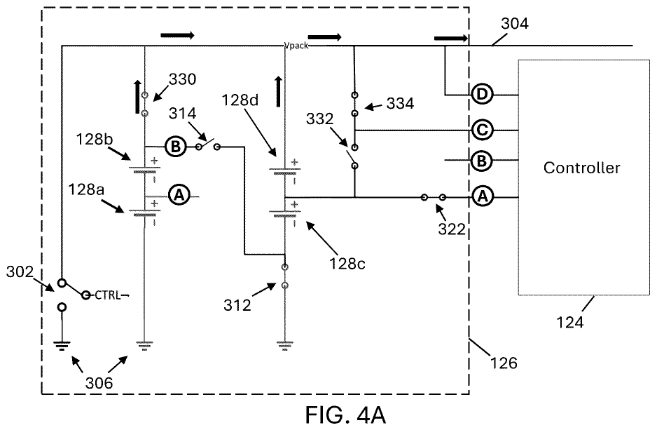

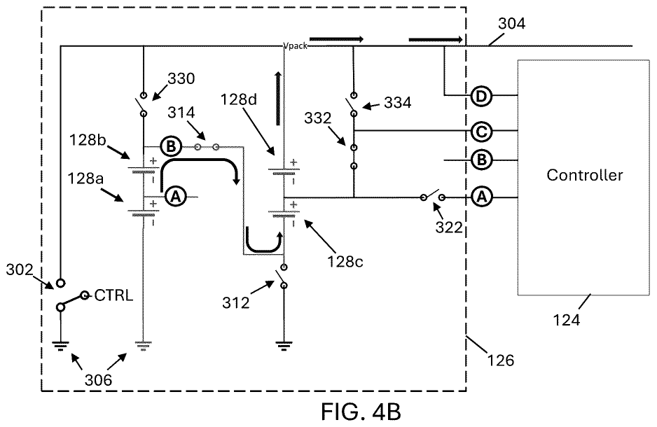

The logic circuit 104 of the media processing device 100 can be operatively coupled to the memory 106, the communications interface 108, the I/O devices 110, the printhead 112, the radiofrequency encoder/reader 114, the motor 116, and/or the temperature compensation circuit 122. The platen roller 120 can be driven by the motor 116 via a drive train 118 to rotate the platen roller 120 about an axis of rotation in a first direction (e.g., clockwise in the orientation shown in FIG. 1) to pull the media 136 through the feed path and can be driven by the motor 116 via the drive train 118 to rotate the platen roller 120 about the axis of rotation in a second direction (e.g., counterclockwise in the orientation shown in FIG. 4) to retract the media 136. In one example, the logic circuit 104 can be configured to execute code stored in the memory 106 to perform operations and functions of the media processing device 100, e.g., by communicating with and/or controlling one or more of the components of the media processing device 100. The logic circuit 104 can execute the code stored memory 106 to implement a printing operation or function that controls the motor 116 to rotate the platen roller 120 to feed the media 136 past the printhead 112, controls the print head 112 to print on the media 136 (either directly or by transferring an ink from a ribbon to the media), and/or controls the RF encoder/reader 114 to encode and/or read radiofrequency circuits (e.g., RFID or NFC tags or inlays) included in or on the media 136. For thermal transfer printing, the printable surface of the media 136 is configured to receive a pigment (e.g., resin, wax-resin, etc.) that is transferred from the ink ribbon 132 installed on the ribbon supply and take-up spindles 130A and 130B, respectively, via an operation of the printhead 112. For direct thermal printing, the printhead 112 of the media processing device 100 can selectively heat the printable surface of the media 136 triggering a chemical or physical change in a thermally sensitive dye covering at least a portion of the printable surface of the media 136. After printing on the media 136, the media can be further advanced and output from media processing device 100 by the operation of the platen roller 120.

The battery pack 122 is configured to power one or more of the components of the media processing device 100 via the battery cells 128. As an example, the battery pack 126 can directly or indirectly power the logic circuit 104, the memory 106, the communication interface 108, the input/output (I/O) devices 110, the printhead 112, the radiofrequency encoder/reader 114, and/or the motor 116. In some embodiments, an external power source (e.g., line voltage from a power grid) can be used to power the components of the media processing device 100 instead of or in addition to the battery pack 122. The cell selector 126 can determine a manner in which the battery cells are electrically connected to each other in the battery pack 122. As an example, the cell selector can configure the battery cells 128 according to cell arraignments including, for example, a first cell arrangement or a second cell arrangement. The first cell arrangement of the battery cells 128 can cause the battery pack to output a supply voltage at a first voltage and the second cell arrangement of the battery cells 128 can cause the battery pack to output a supply voltage at a second voltage. The cell selector 126 can selectively switch between the first and second cell arrangements based on the printer using the battery pack 122 or a battery charger that is charging the battery cells 128 of the battery packs. The controller 124 can be configured to manage an operation of the battery pack 122. As an example, the controller can be operable to interface with the cell selector 126 to monitor the battery cells 128, ensure balanced charging of the battery cells, and/or control the cell selector 126 to switch between the cell arraignments, e.g., the first cell arrangement and the second cell arrangement. When the battery pack is operatively coupled to the media processing device 100, the controller 124 can be in communication with the logic circuit 104. As an example, the controller 124 can be configured to provide the logic circuit 104 information about the cell arrangements (e.g., the cell arrangement current selected via the cell selector 126), a remaining charge available from the battery cells 128 using the currently selected cell arrangement, a remaining charge available from the battery cells 128 using one of the other cell arrangements that are not currently selected, a charge capacity of the battery cells 128, a time period until the battery cells 128 should be recharged, a time period until the battery 128 should be replaced, and/or other information about the battery pack 122. In some examples, the cell selector selects the cell arrangement independently from the controller 124 (e.g., without a control signal from the controller).

While an embodiment of the device 100 is illustrated as including certain components, embodiments of the device 100 can include more, fewer, or different components. While FIG. 1 describes an embodiment of a media processing device for illustrative purposes, embodiments of the present disclosure can be implemented as a different type of electronic device, such as but not limited to mobile computing device, barcode scanners, or other electronic devices that are powered by batteries.

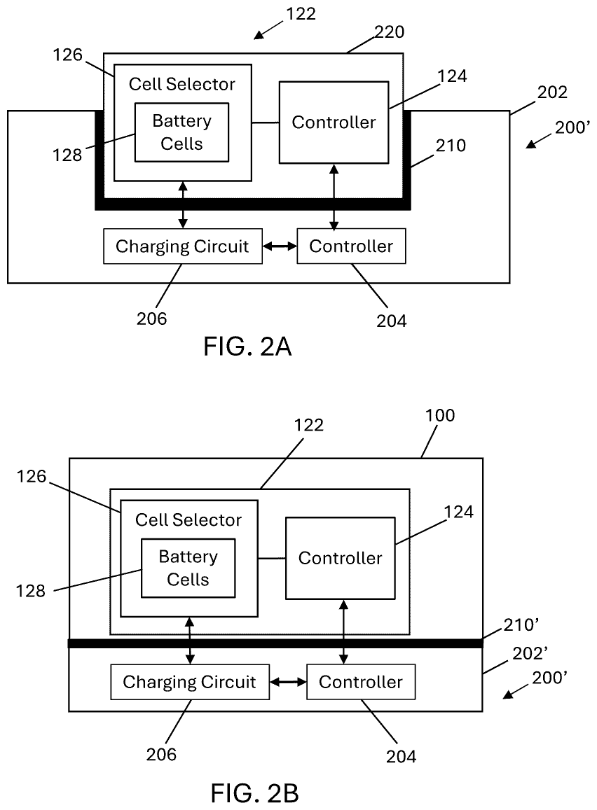

FIG. 2A is a schematic view of an example battery charger 200 operatively coupled to an embodiment of the battery pack 122 in accordance with embodiments of the present disclosure. The battery charger 200 can include a housing 202 that defines a battery pack receiving area 210 in the form of a battery compartment, battery well, or battery docking area configured to receive and support a housing 220 the battery pack 122. In one example, the battery pack receiving area 210 can include an electrical interface to electrically couple the battery pack 122 to one or more of the electronic components in the battery charger 200, e.g., controller 204 and charging circuit 206. In one example, the battery pack receiving area 210 can include a wireless charging interface to wirelessly couple the controller 124 and/or cell selector 126 of the battery pack 122 to one or more of the electronic components in the battery charger 200, e.g., controller 204 and charging circuit 206.

FIG. 2B is a schematic view of an example battery charger 200′ operatively coupled to an embodiment of the media processing device 100 including the battery pack 122 in accordance with embodiments of the present disclosure. The battery charger 200 can include a housing 202′ that defines a device receiving area 210′ in the form of battery docking area configured to receive and support the media processing device 100. In one example, the device receiving area 210′ can include an electrical interface to electrically couple the battery pack 122 of the media processing device 100 to one or more of the electronic components in the battery charger 200′, e.g., controller 204 and charging circuit 206. In one example, the battery pack receiving area can include a wireless charging interface to wirelessly couple the controller 124 and/or cell selector 126 of the battery pack 122 to one or more of the electronic components in the battery charger 200′, e.g., controller 204 and charging circuit 206.

Referring to FIGS. 2A-B, the charging circuit 206 can receive power from a power supply, e.g., line voltage, and can provide a voltage to the battery pack 122 to charge the battery cells 126 of the battery pack 122. The cell selector 126 can selectively switch between the first and second cell arrangements based on the battery charger 200, 200′. The controller can be operable to interface with the cell selector 126 to monitor the battery cells 128, ensure balanced charging of the battery cells, and/or control the cell selector 126 to switch between the cell arraignments, e.g., the first cell arrangement and the second cell arrangement. When the battery pack is operatively coupled to the battery charger 200, 200′, the controller 124 can be in communication with the controller 204. As an example, the controller 124 can be configured to provide the controller 204 information about the cell arrangements (e.g., the cell arrangement current selected via the cell selector 126), a remaining charge available from the battery cells 128 using the currently selected cell arrangement, a remaining charge available from the battery cells 128 using one of the other cell arrangements that are not currently selected, a charge capacity of the battery cells 128, a time period until the battery cells 128 should be recharged, a time period until the battery pack 122 should be replaced, and/or other information about the battery pack 122. In some examples, the cell selector selects the cell arrangement independently from the controller 124 (e.g., without a control signal from the controller).

With reference to FIG. 2A, in some embodiments, the battery cells 128 can have the first cell arrangement when the battery pack is operatively coupled to the media processing device 100 and can have the second cell arrangement when the battery pack is operatively coupled to the battery charger 200.

With reference to FIGS. 2A-B, in some embodiments, the configuration of the battery receiving areas 140 (FIG. 1), the battery receiving area 210, and/or the device receiving area 210′ can determine which cell arrangement is selected by the cell selector 126. In some embodiments, the controller 104 (FIG. 1) and/or the controller 204 can negotiate with the controller 124 to determine which cell arrangement is selected by the cell selector 126 and the controller 124 can control an operation of the cell selector 126 to select the cell arrangement based on the determination.

The charging circuit 206 can receive power from a power supply, e.g., line voltage, and can provide a voltage to the battery pack 122 to charge the battery cells 128 of the battery pack 122. The cell selector 126 can selectively switch between the first and second cell arrangements based on the battery charger 200, 200′. The controller can be operable to interface with the cell selector 126 to monitor the battery cells 128, ensure balanced charging of the battery cells, and/or control the cell selector 126 to switch between the cell arraignments, e.g., the first cell arrangement and the second cell arrangement. When the battery pack is operatively coupled to the battery charger 200, 200′, the controller 124 can be in communication with the controller 204. As an example, the controller 124 can be configured to provide the controller 204 information about the cell arrangements (e.g., the cell arrangement current selected via the cell selector 126), a remaining charge available from the battery cells 128 using the currently selected cell arrangement, a remaining charge available from the battery cells 128 using one of the other cell arrangements that are not currently selected, a charge capacity of the battery cells 128, a time period until the battery cells 128 should be recharged, a time period until the battery pack 122 should be replaced, and/or other information about the battery pack 122. In some examples, the cell selector selects the cell arrangement independently from the controller 124 (e.g., without a control signal from the controller).

In some embodiments, the battery cells 128 can have the first cell arrangement when the battery pack is operatively coupled to or operating the media processing device 100 and can have the second cell arrangement when the battery pack is operatively coupled to the battery charger 200, 200′. In some embodiments, a configuration of the battery receiving areas 140 (FIG. 1), the battery receiving area 210, and/or the device receiving area 210′ can determine which cell arrangement is selected by the cell selector 126. In some embodiments, the logic circuit 104 (FIG. 1) and the controller 204 can negotiate with the controller 124 to determine which cell arrangement is selected by the cell selector 126 and the controller 124 can control an operation of the cell selector 126 to select the determined cell arrangement.

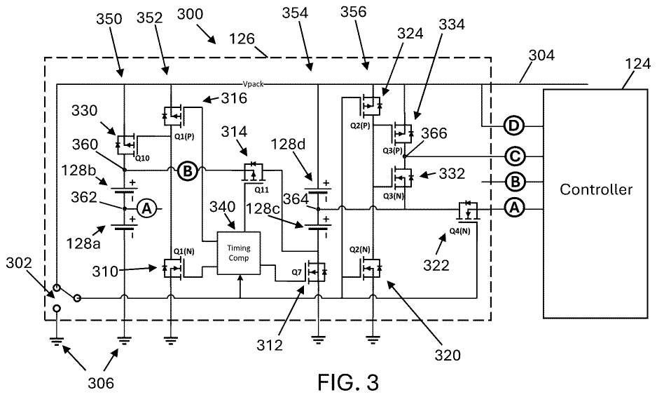

FIG. 3 illustrates circuitry 300 of an example embodiment of the battery pack 122 in accordance with the present disclosure. FIG. 4A is a simplified illustration of the circuitry 300 when the control switch 302 is coupled to the output voltage line 304 and FIG. 4B is a simplified illustration of the circuitry 300 when the control switch 302 is coupled to ground 306. As shown in FIG. 3, the cell selector 126 can include the battery cells 128a-d. The cell selector 126 can be responsive to a control signal, which, in the present embodiment, can be generated based on a state of a control switch 302 that is configured to switch between a first cell arrangement and a second cell arrangement. Based on the state of the switch, the control signal can switch between an output voltage on an output voltage line 304 of the battery pack 122 and ground 306. As an example, when the control signal is the output voltage on the output voltage line 304, the cell selector 1126 can configure the battery cells 128a-d according to the first cell arrangement, and when the control signal is ground 306, the cell selector 1126 can configure the battery cells 128a-d according to the second cell arrangement. In the first cell arrangement, the battery cells 128a-b can be a first pair of battery cells in a series circuit arrangement with each other and the battery cells 128c-d can be a second pair of battery cells in a series circuit arrangement with each other, where the first and second pairs of battery cells are in a parallel circuit arrangement with each other. The output voltage on the output voltage line 304 when the first cell arrangement selected can be equal to a first output voltage. In the second cell arrangement, the battery cells 128a-d can be in a series circuit arrangement with each other. The output voltage on the output voltage line 304 when the second cell arrangement selected can be equal to a second output voltage. The second output voltage can be greater than the first output voltage (e.g., the second output voltage can be two times greater than the first output voltage). While an illustrative embodiment of the circuitry, provides for four battery cells 128 and/or particular first and second cell arrangements based on the state of the control switch 302, embodiments of the circuitry 300 can include more or fewer battery cells 128 and/or can provide for more and/or different cell arrangements. As one example, the circuitry 300 can provide for a third cell arrangement in which the battery cells are in a parallel circuit with each other. As another example, the circuitry 300 can include two battery cells 128 and the circuitry 300 can provide for a cell arrangement in which the two battery cells are in a parallel circuit with each other and another cell arrangement in which the two battery cells are in a series circuit with each other.

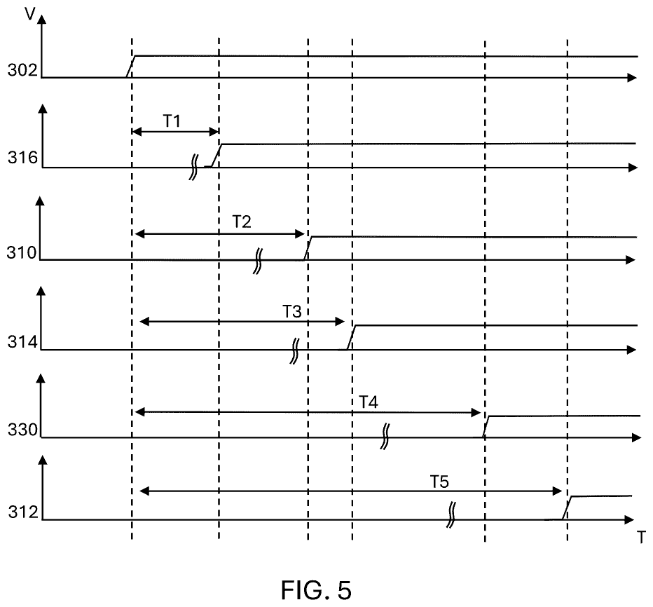

The cell selector 126 can includes transistors 310-316, 320-324, and 330-334, timing compensation circuitry 340, and the battery cells 128. The timing compensation circuitry 340 can include circuit elements/components configured to introduce timing delays in the circuitry 300. As one example, the timing compensation circuitry 340 can include resistors and capacitors arranged, for example, in one or more topologies (e.g., such as a low pass filter topology). The output of the control switch 302 can be operatively coupled to the transistors 310-316 and 320-324 to control the transistors to operate as switches (e.g., the transistors 310-316, 320-324, and/or 330-334 can be operated in cut-off mode or saturation mode based on the control signal). The transistors 310-316, 320-324, and/or 330-334 can be any suitable type of transistor capable of being operated as a switch. In the present example, the transistors are illustrated as metal-oxide-semiconductor field-effect transistors (MOSFETS). In some examples, one or more of the transistors 310-316, 320-324, and 330-334 can be implemented using electromechanical switches (e.g., relays, solenoids, etc.). The output of the control switch 302 can be operatively coupled to the gates of the transistors 310-316 and 320-324. In the present example, the output of the control switch 302 can be operatively coupled to the gates of the transistors 310-316 via the timing compensation circuitry 340, which can adjust the timing at which and/or sequence in which the transistors 310-316 switch in response to changes to the control signal from the control switch 302 (e.g., by delaying the control signal to the gates of the transistors 310-316). An example timing diagram for the timing at which and/or sequence in which the transistors 310-316 switch in response to changes to the control signal from the control switch 302 is shown in FIG. 5.

As shown in FIG. 3, the circuitry 300 includes a first leg 350, a second leg 352, a third leg 354, and a fourth leg 356. The first leg 350 includes the battery cell 128a having its negative terminal (or anode) coupled to ground and its positive terminal (or cathode) coupled to the negative terminal (or anode) of the battery cell 128b. The positive terminal (or cathode) of the battery cell 128b is coupled to the drain of the (p-channel) transitory 330 and the source of the transistor 330 is coupled to the output voltage line 304. The second leg 352 includes the transistors 310 and 316. The source of the (n-channel) transistor 310 is coupled to ground and the drain of the transistor 310 is coupled to the gate of the transistor 330 and to the drain of the (p-channel) transistor 316. The source of the transistor 316 is coupled to the output voltage line 304. The gates of the transistors 310 and 316 are operatively coupled to the control switch 302 via the timing compensation circuitry 340. The third leg 354 includes the transistor 312 and the battery cells 128c and 128d. The source of the (n-channel) transistor 312 is coupled to ground 306 and the drain of the transistor 312 is coupled to the negative terminal (or anode) of the battery cell 128c. The gate of the transistor 312 is operatively coupled to the control switch 302 via the timing compensation circuitry 340. The positive terminal (or cathode) of the battery cell 128d is coupled to the negative terminal (or anode) of the battery cell 128 and the positive terminal (or cathode) of the battery terminal 128d is coupled to the output voltage line 304. The drain of the transistor 312 is also coupled to the drain of the (p-channel) transistor 314 and the source of the transistor 314 is coupled to a node 360 between the drain of the (p-channel) transistor 330 and the positive terminal of the battery cell 128b. A node 362 between the positive terminal of the battery cell 128a and the negative terminal of the battery cell 128b is coupled to the controller 124. The fourth leg 356 includes the transistors 320 and 324. The source of the (n-channel) transistor 320 is coupled to ground and the drain of the transistor 320 is coupled to the gates of the transistors 332 and 334 and to the drain of the transistor 324. The source of the (p-channel) transistor 324 is coupled to the output voltage line 304. The gates of the transistors 320 and 324 are coupled to the control switch 302. The source of the (n-channel) transistor 332 is coupled to a node 364 between the positive terminal of the battery cell 128c and a negative terminal of the battery cell 128d and is also coupled to the drain of the (n-channel) transistor 322. The gate of the transistor 322 is coupled to the control switch 302 and the source of the (n-channel) transistor 322 is coupled to the controller 124. The source of the (n-channel) transistor 332 is coupled to the node 364 between the positive terminal of the battery cell 128c and the positive terminal of the battery cell 128d (as well as to the drain of the (n-channel) transistor 322. The drain of the (n-channel) transistor 332 is coupled to the drain of the (p-channel) transistor 334 at a node 366 to which the controller 124 is also coupled. The source of the transistor 334 is coupled to the output voltage line 304 and the output voltage line is also coupled to the controller 124.

With reference to FIGS. 3 and 4A, when the control switch 302 is coupled to the output voltage line 304, the transistors 310, 312, 320, 322, 330, and 334 are in the saturation mode and operate as closed switches allowing current to flow through them, while the transistors 314, 316, 324, and 332 are in the cut-off mode and operate as open switches preventing current from flowing through them. In this arrangement, the battery cells 128a-b are in series with each other, the battery cells 128c-d are in series with each other, and the battery cells 128a-b are in parallel with the battery cells 128c-d.

With reference to FIGS. 3 and 4B, when the control switch 302 is coupled to ground, the transistors 310, 312, 320, 322, 330, and 334 are in the cut-off mode and operate as open switches preventing current from flowing through them, while the transistors 314, 316, 324, and 332 are in the saturation mode and operate as closed switches allowing current to flow through them. In this arrangement, the battery cells 128a-d are in series with each other.

The controller 124 can output voltages for charge balancing between the battery cells 128a-d. As an example, a first output ‘A’ of the controller 124 can be connected to the node 362 and can be selectively connected to the node 364. As another example, a second output ‘B’ of the controller 124 can be connected to the node 360. As another example, a third output ‘C’ of the controller 124 can be selectively connected to the node 364 or can be selectively connected to the output voltage line 304. As another example, a fourth output ‘D’ of the controller 124 can be connected to the output voltage line 304.

The battery cells 128a-d in the present example can be specified to have the same output voltage capability. As a non-limiting example, each of the battery cells 128a-d can be specified to output four volts when charged. In the cell arrangement shown in FIG. 4A, where the battery cells 128a-b are in a series circuit with each other, the battery cells 128c-d are in a series circuit with each other, and the battery cells 128a-b and battery cells 128c-d are in a parallel circuit with each other, the voltage at the nodes 362 and 364 can be at or held to the same voltage (e.g., 4 volts) and the nodes 360 and 364 can be held at the same voltage (e.g., 8 volts), e.g., the output voltage of the battery in the cell arrangement shown in FIG. 4A. When the battery cells 128a-d are arranged according to the cell arrangement shown in FIG. 4A, for example, the output ‘A’ is connected to the node 362 and is connected to the node 364 (via transistor 322) to output a first voltage (e.g., 4 volts). The output ‘B’ of the controller is connected to the node 360 (and the output line 304 via the transistor 330), the output ‘C’ is connected to the output voltage line 304 via the transistor 334, and the output ‘D’ is connected to the output voltage line 304. The outputs ‘B’, ‘C’, and ‘D’ can output a second voltage (e.g., 8 volts).

In the cell arrangement shown in FIG. 4B, where the battery cells 128a-d are in a series circuit with each other, the voltage at the nodes 360, 362, 364, 364 can each be at or held to the different voltages. When the battery cells 128a-d are arranged according to the cell arrangement shown in FIG. 4B, for example, the output ‘A’ of the controller 124 is connected to the node 362 to output a first voltage (e.g., 4 volts), the output ‘B’ of the controller 124 is connected to the node 360 to output a second voltage (e.g., 8 volts), the output ‘C’ is connected to the node 364 via the transistor 332 to output s third voltage (e.g., 12 volts), and the output ‘D’ is connected to the output voltage line 304 to output a fourth voltage or the output voltage of the battery pack in the cell arrangement shown in FIG. 4B (e.g., 16 volts).

FIG. 5 is an example timing diagram illustrating a switching sequence/scheme for the circuitry 300 based on an operation of the timing compensation circuitry 340 in accordance with embodiments of the present disclosure. FIG. 5 illustrate a transition of the control switch 302 from ground 306 to the output voltage line 304. The timing compensation circuity 340 can control a timing at which the transistors 310-316 and 330 respond to the control switch changing states from ground to the output voltage, e.g., to prevent shoot through current through the transistors. In the present example, the timing compensation circuitry 340 can introduce delays to the pulse formed by the transition of the control switch 302 so that the voltage of the gates of the transistors 310-316 and 330 changes to the output voltage according to the switching sequence/scheme. As an example, the timing compensation circuitry 340 can introduce a first time delay T1 before the gate voltage of the transistor 316 transitions from ground to the output voltage, can introduce a second time delay T2 (that is great than the time delay T1) before the gate voltage of the transistor 310 transitions from ground to the output voltage, can introduce a third time delay T3 (that is great than the time delays T1 and T2) before the gate voltage of the transistor 314 transitions from ground to the output voltage, can introduce a fourth time delay T4 (that is great than the time delays T1-T3) before the gate voltage of the transistor 330 transitions from ground to the output voltage, and/or can introduce a fifth time delay T5 (that is great than the time delays T1-T4) before the gate voltage of the transistor 312 transitions from ground to the output voltage. In one example, the first and second time delays can be on the order of tens of nanoseconds, the third and fourth time delays can be in the order of microseconds, and the fifth time delay can be on the order of tens of microseconds. While FIG. 5 illustrates an example switching sequence/scheme for the transistors 310-316 and 330, embodiments of the present disclosure can implement different switching sequences/schemes and/or the time delays for the switching sequence/scheme can be different.

While FIGS. 1-5 illustrate an example embodiment of the battery pack 122, exemplary embodiments of the battery pack 122 can include more or fewer components and/or can include different components. Also, while FIGS. 3-5 illustrate example circuitry 300 of an example embodiment of the battery pack 122, exemplary embodiments of the circuitry can be configured using different devices (MOSFET transistors, Bipolar Junction Transistors (BJTs), relays, solenoids, etc.), configurations and/or logic, and different cell arrangements, e.g., based on circuit topologies, combinational logic, and/or other schemes.

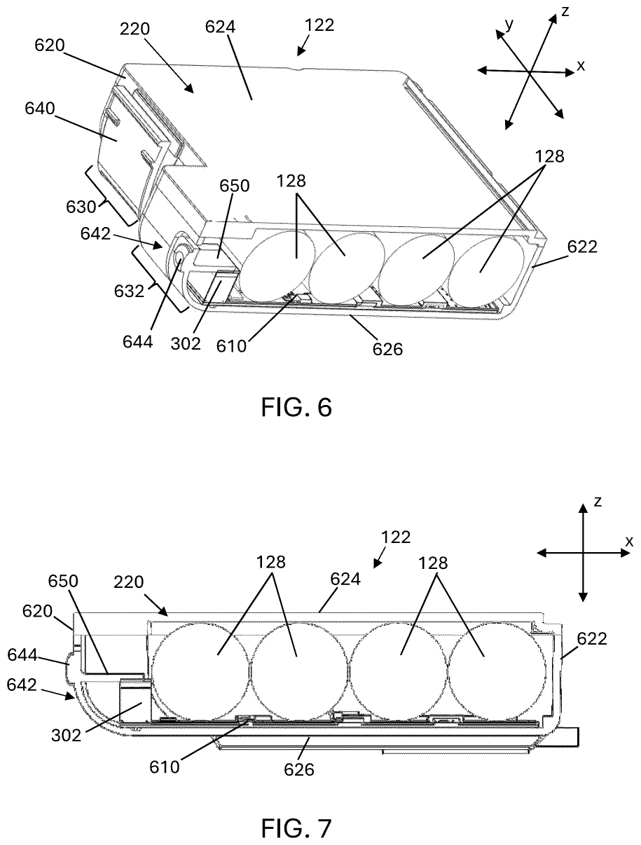

FIGS. 6-7 illustrates a cross-sectional view of an example embodiment of the battery pack 122 in accordance with embodiments of the present disclosure. As shown in FIGS. 6-7, the housing 220 of the battery pack 122 can contain the circuitry 300 including the controller, cell selector, and battery cells 128. As an example, the housing 220 can contain a circuit board 610 supporting the controller and cell selector 126 and can be operatively coupled to one or more terminals of one or more of the battery cells as described herein, e.g., with reference to FIGS. 3-5.

The housing 220 can have a length measured along a first axis (e.g., an x-axis) between a first side 620 and second side 622 of the housing 220, a height measured along a third axis (e.g., a z-axis) between a third side 624 and a fourth side 626 of the housing 220, and a width measure along a second axis (e.g., a y-axis) between a fifth side and sixth side, where the first through third axes are perpendicular to each other (e.g., the x-axis, y-axis, and z-axis are perpendicular to each other). The housing 220 can include additional side not visible in the cross-sectional view illustrated in FIGS. 6-7 (e.g., the fifth and sixth sides). In some embodiments, one of the sides of the housing 220 can include or provide access to an electrical interface that facilitates electrical connection to another device (e.g., the media processing device 100, the battery charger 200, etc.). In the present example, the fourth side 626 can include the electrical interface. As shown in FIG. 6, the housing 220 can be generally rectangular-shaped. In the present example, the first side 620 can have a stepped configuration such that the housing 220 can have a first length measured along the first axis (e.g., the x-axis) between a first portion 630 of the first side 620 and the second side 622 and can have a second length measured along the first axis between a second portion 632 of the first side 620 and the second side 622, where the second length can be greater than the first length. The first portion 630 can include a first resilient member 640 forming a first detent that is configured to engage a corresponding locking structure of a housing of another device (e.g., the media processing device 100, the battery charger 200, etc.) to aid in securing the battery pack to the other device. In some embodiments, in which the housing of the other device configured to receive the battery pack 122 is configured to enclose or other secure the battery pack 122, the battery pack 122 can be devoid of the first resilient member 640. The second portion 632 of the first side 620 can include a second resilient member 642 forming a depressible or cantilevered mechanical button. In the present embodiment, the second resilient member 642 can be integrally formed with the second portion 632 and/or can be generally flush with the second portion 632 except that a button portion 644 disposed proximate to a terminal end of the resilient member 642 can be raised or project outwardly away from the second portion 632 of the second side 620. The button portion 644 can be depressed inwardly (e.g., into an interior of housing 220) to interact with the control switch 302 (e.g., an electro-mechanical switch in the present example). An arm 650 can extend from an interior side of the resilient member 642 into the interior volume of the housing 220 and a portion of the arm 650 can be configured to selectively engage the control switch to switch the control switch between two states. As an example, when and while the button portion 644 is depressed, the resilient member 642 can be flex about an anchor point (e.g., a point at which the cantilever originates) causing the arm 650 to move (e.g., along the z-axis) to engage the control switch 302. When the button portion 644 is released, the resilient member 642 can return to starting position and the arm 650 can disengage the control switch 302.

While FIGS. 6-7 illustrate an example embodiment in which the control switch 302 is an electro-mechanical switch, in other embodiments the control switch can be an electronic switch that is controlled via an electronic control signal, e.g., from the controller, 104, 124, and/or 204. As an example, the control switch 302 can be a transistor that is responsive to a control signal (e.g., from the controller 104, 124, and/or 204), a proximity switch (e.g., capacitive or inductive proximity switch) that switches states when the control switch 302 is received by a battery receiving area (e.g., battery receiving area 140, 210, 210′, 802, 1102), an optical switch that switches states when the control switch 302 is received by a battery receiving area (e.g., battery receiving area 140, 210, 210′, 802, 1102). Additionally, or in the alternative, while FIGS. 6-7 illustrate an example embodiment of the housing 220 of the battery pack 122, exemplary embodiments of the battery pack 12 can have differently shaped housings and/or different structures for selectively engaging the control switch 302 for embodiments in which the control switch is an electro-mechanical switch.

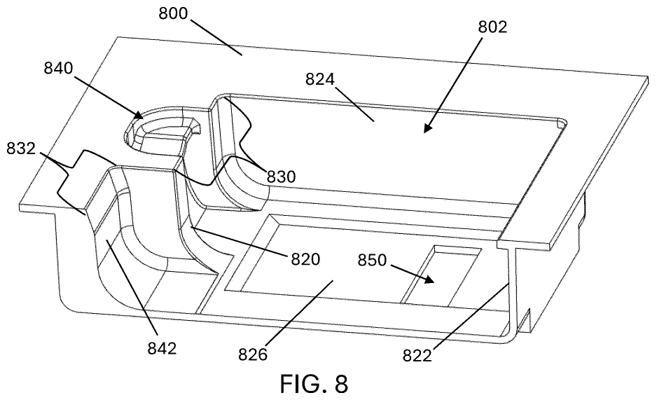

FIG. 8 illustrates a cross-sectional view of a portion of a housing 800 of a device that is configured to interface with the embodiment of the battery pack 122 illustrated in FIGS. 6-7 in accordance with embodiments of the present disclosure. In one example, the device can be an embodiment of the media processing device 100 where the portion of the housing 800 forms part of the housing 102, an embodiment of the battery charger 200 where the portion of the housing 800 forms part of the housing 202, an embodiment of the battery charger 200′ where the portion of the housing 800 forms part of the housing 202′, or another device configured to receive battery pack 122. As shown in FIG. 8, the housing 800 can include a battery receiving area 802, e.g., a battery compartment or battery well, configured and dimensioned to receive the housing 220 of the battery pack 122. For example, the battery receiving area 802 can have a complementary shape to the housing 220 illustrated in FIGS. 6-7. The battery receiving area 802 can have sides including a first side 820, a second side 822, a third side 824, and a fourth side 826. The battery receiving 802 can include additional side not visible in the cross-sectional view illustrated in FIG. 8. The first side 820 can have a first portion 830 and a second portion 832. The first portion 830 can include a locking structure 840 that is configured to engage the first resilient member 640 of the battery pack, shown in FIGS. 6-7, to secure the battery pack within the battery receiving area 802. The second portion 832 can define a volume within the battery receiving area 802 for receiving the second portion 632 of the battery pack 122 shown in FIGS. 6-7. A surface 842 of the second portion 832 can be configured to engage the button portion 644 of the battery pack shown in FIGS. 6-7. The fourth side 826 of the battery receiving area 802 can include an opening 850 configured to receive an electrical interface of the device that is configured to interface with the electrical interface of the battery pack 122. In one example, the battery receiving area 802 to correspond to the battery receiving area 140 of the device 100 shown in FIG. 1 and/or the battery receiving area 210 of the battery charger 200 shown in FIG. 2A.

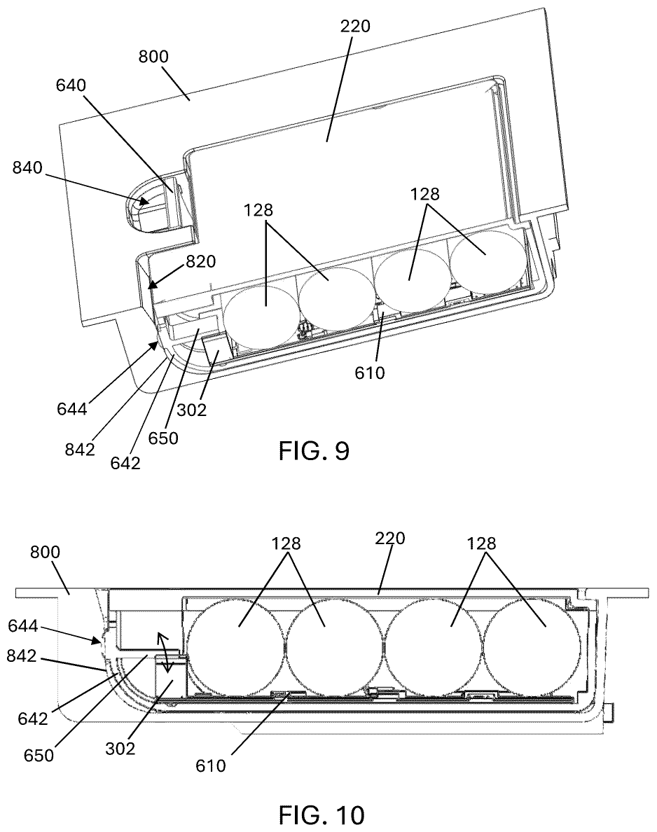

FIGS. 9-10 illustrates a cross-sectional view of the portion of the housing 800 of FIG. 8 with the embodiment of the battery pack 122 illustrated in FIGS. 6-7 received within the battery well 802 in accordance with embodiments of the present disclosure. As shown in FIGS. 9-10, the embodiment of the housing 220 of the battery pack 122 generally fits within the complementary shape of the battery pack 122. The first resilient member 640 can engage the locking structure 840 to secure the housing 220 to the housing 800. The surface 842 of the second portion 832 engages and depresses the button portion 644 of the battery pack 122 when the battery pack 122 is secured within the battery well 802 causing the arm 650 to engage the control switch 302; and thereby control the cell selector circuit on the circuit board 610 to select one of the cell arrangements for the battery cells 128 that corresponds to the state of the control switch, as described herein, e.g., with reference to FIGS. 3-5.

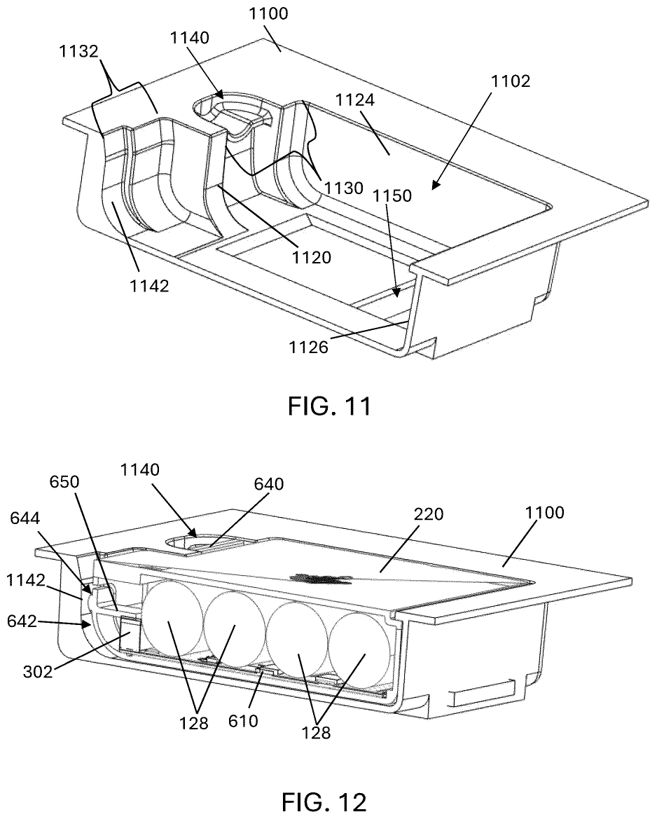

FIG. 11 illustrates a cross-sectional view of a portion of a housing 1100 of a device that is configured to interface with the embodiment of the battery pack 122 illustrated in FIGS. 6-7 in accordance with embodiments of the present disclosure. In one example, the device can be an embodiment of the media processing device 100 where the portion of the housing 800 forms part of the housing 102, an embodiment of the battery charger 200 where the portion of the housing 800 forms part of the housing 202, or another device configured to receive battery pack 122. As shown in FIG. 11, the portion of the housing 1100 can include a battery receiving area 1102, e.g., battery compartment or battery well, configured and dimensioned to receive the housing 220 of the battery pack 122. For example, the battery receiving area 1102 can have a complementary shape to the housing 220 illustrated in FIGS. 6-7. The battery receiving area 1102 can have sides including a first side 1120, a second side 1122, a third side 1124, and a fourth side 1126. The battery receiving area 1102 can include additional side not visible in the cross-sectional view illustrated in FIG. 11. The first side 1120 can have a first portion 1130 and a second portion 1132. The first portion 1130 can include a locking structure 1140 that is configured to engage the first resilient member 640 of the battery pack 122, shown in FIGS. 6-7, to secure the battery pack 122 within the battery receiving area 1102. The second portion 1132 can define a volume within the battery receiving area 1102 for receiving the second portion 632 of the battery pack 122 shown in FIGS. 6-7. A surface 1142 of the second portion 1132 can be configured to be spaced away from the button portion 644 of the battery pack 122 shown in FIGS. 6-7. For example, the surface 1142 can be recessed further a remainder of the second portion 1132 to create a space, cavity, or cutout in the second portion that can receive the button portion of the battery pack 122 without the surface 1142 engaging or otherwise depressing the button portion. The fourth side 826 of the battery well 802 can include an opening 1150 configured to receive an electrical interface of the device that is configured to interface with the electrical interface of the battery pack 122. In one example, the battery receiving area 1102 to correspond to the battery receiving area 140 of the device 100 shown in FIG. 1 and/or the battery receiving area 210 of the battery charger 200 shown in FIG. 2A.

FIG. 12 illustrates a cross-sectional view of the portion of the housing 1100 of FIG. 11 with the embodiment of the battery pack 122 illustrated in FIGS. 6-7 received within the battery receiving area 1102 in accordance with embodiments of the present disclosure. As shown in FIG. 12, the embodiment of the housing 220 of the battery pack 122 generally fits within the complementary shape of the battery pack 122. The first resilient member 640 can engage the locking structure 1140 to secure the housing 220 to the housing 1100. The surface 1142 of the second portion 1132 is spaced away from the button portion 644 of the second resilient member 642 of the battery pack 122 when the battery pack 122 is secured within the battery receiving area 1102 causing the arm 650 to be disengaged from the control switch 302; and thereby controlling the cell selector circuit on the circuit board 610 to select one of the cell arrangements for the battery cells 128 that corresponds to the state of the control switch, as described herein, e.g., with reference to FIGS. 3-5.

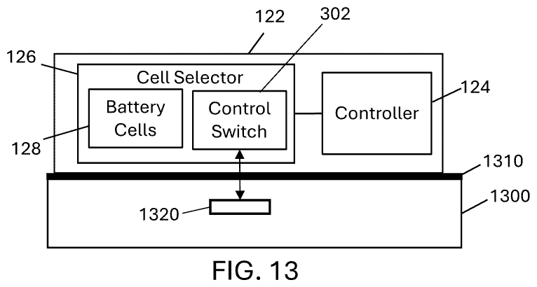

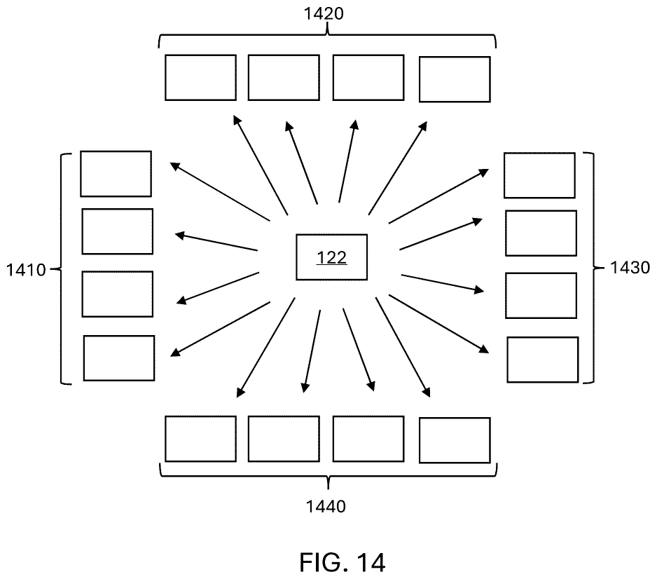

FIG. 13 is a schematic view of an embodiment of the battery pack 122 in which the control switch 302 is a non-contact switch in accordance with embodiments of the present disclosure. As shown in FIG. 13, a battery/device receiving area 1310 of an electronic device 1300 can received the battery pack 122. The electronic device 1300 can correspond to an embodiment of the device 100, the battery charge 200, and/or the battery charger 200′ and the receiving area 1310 can correspond to an embodiment of the receiving areas 140, 210, 210′, 802, and/0r 1102. When the battery pack is received by the receiving area 1310, the control switch 302 can output a control signal that controls the cell selector 126 to selectively switch between cell arrangements. In one example, the control switch 302 is a proximity switch (inductive or capacitive proximity) that senses when the control switch is disposed proximate to a target 1320 (e.g., a conductive material, a dielectric material). When the control switch 302 is disposed away from the target 1320 (e.g., not in proximity, more than a specified distance away), the control signal generated by the control switch can cause the cell selector to configure the battery cells 128 according to a first cell configuration and when the control switch is proximate to the target 1320 (e.g., in proximity, less than a specified distance away), the control signal generated by the control switch can cause the cell selector to configure the battery cells 128 according to a second cell configuration.

In another example, the control switch 302 is optical switch that sense that is sensitive to light at a specified wavelength or within a specified range of wavelength, such as infrared light. In this example the reference number 1320 can denote an emitter that emits light at the specified wavelength or within the specified wavelength range. When the battery pack 122 is received by the receiving area 1310, the control switch 302 can be aligned with the emitter 1320 and the light from the emitter 1320 can impinge upon the control switch (e.g., a photodiode). When the light from emitter 1320 does not impinge upon the control switch 302, the control signal generated by the control switch 302 can cause the cell selector to configure the battery cells 128 according to a first cell configuration and when the light from the emitter impinges upon the control switch 302, the control signal generated by the control switch 302 can cause the cell selector to configure the battery cells 128 according to a second cell configuration. In this example, for embodiments of the device 1300 that receive power from a source other than the battery pack 122, the emitter 1320 can be powered via the other power source. For embodiments in which the device 1300 is powered by the battery pack 122, the battery pack 122, when received via the receiving area 1310, can provide power to the device to power the emitter 1320. In some embodiments, the control switch 302 can include the emitter 1320 and a receiver (e.g., a photodiode) such that the control switch 302 can emit light and detect whether the light is reflected (e.g., by the receiving area 1310 or the target) and the presence or absence of reflected light can control whether the cell selector 126 configures the battery cells according to a first call arrangement or a second cell arrangement.

In another example, the control switch 302 is radiofrequency (RF) switch. In this example the reference number 1320 can denote a RF tag (e.g., a RFID tag or NFC tag) that is responsive to an RF interrogation signal from the control switch 302. When the battery pack 122 is received by the receiving area 1310, the RF tag 1320 can respond to the RF interrogation signal from the control switch 320. When the RF tag responds to the RF interrogation signal from the control switch 302, the control signal generated by the control switch 302 can cause the cell selector to configure the battery cells 128 according to a first cell configuration and when the RF tag does not respond to RF interrogation signal from the control switch 302, the control signal generated by the control switch 302 can cause the cell selector to configure the battery cells 128 according to a second cell configuration. In some examples, the data provided by the RF tag in response to the RF interrogation signal can be verified and/or authenticated by the battery pack 122 (e.g., by the controller 124 of the battery pack 122) and the control switch can generate a control signal based on whether the data has been successfully verified and/or authenticated.

FIG. 14 illustrates an example system 1400 that can include a set of first electronic devices 1410, a set of second electronic devices 1420, a set of third electronic devices 1430, and a set of fourth electronic devices 1440. The set of first electronic devices 1410 can correspond to an embodiment of the battery charge 200 that includes the portion of the housing 800 shown in FIG. 8 and the second set of devices 1420 can correspond to an embodiment of the battery charge 200 that includes the portion of the housing 1100 shown in FIG. 11. The set of third devices 1430 can correspond to an embodiment of the media processing device 100 that includes the portion of the housing 800 shown in FIG. 8 and the fourth set of devices 1440 can correspond to an embodiment of the battery charge 200 that includes the portion of the housing 1100 shown in FIG. 11. Each of the first through fourth devices 1410-1440 can be configured to received and electrically interface the battery pack 122 described herein. In this example, the first and third devices 1410 and 1430 can be configured to operate and interface with the battery pack 122 using a first cell arrangement for the battery cells 128, where the first devices 1410 can be configured to charge the battery cells according to a first voltage and the third device 1430 are configured to receive the first voltage from the first arrangement of the battery cells to facilitate an operation of the third devices 1430. The second and fourth devices 1420 and 1440 can be configured to operate and interface with the battery pack 122 using a second cell arrangement for the battery cells 128, where the second devices 1420 can be configured to charge the battery cells 128 according to a second voltage and the fourth devices 1440 are configured to receive the second voltage from the second arrangement of the battery cells 128 to facilitate an operation of the third devices 1430. The battery pack 122 can be interchangeable between the first through fourth devices 1410-1440 where the cell arrangement of the battery cells 128 can be reconfigured according to the cell selector to be compatible with the voltage requirements of the first through fourth devices 1410-1440.

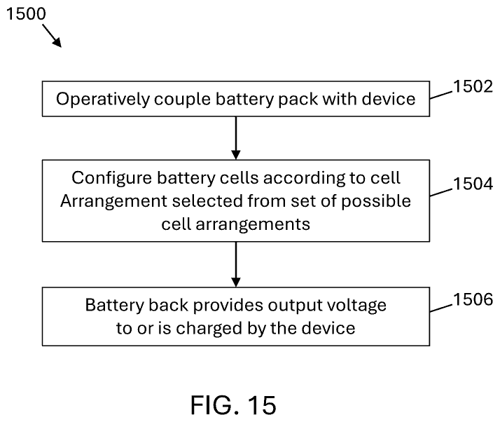

FIG. 15 is a flowchart illustrating an example process 1500 in accordance with embodiments of the present disclosure. At operation 1502, a battery pack (e.g., an embodiment of the battery pack 122) is operatively coupled to an electronic device (e.g., an embodiment of the device 100, 200, or 200′). At 1504, in response to being operatively coupled to the electronic device, battery cells (e.g., battery cells 128) of the battery pack are configured in a cell arrangement selected from a set of possible cell arrangements (e.g., cell arrangements shown in FIGS. 4A-B) by operation of a cell selector (e.g., cell selector 126). As an example, the cell selector can be controlled by a control switch (e.g., control switch 302) to switch between the possible cell arrangements. At step 1506, the battery pack provides an output voltage to the device based on the selected cell arrangement or the battery cells of the battery pack are charged/recharged by the device based on the selected cell arrangement.

The above description refers to diagrams of the accompanying drawings. Alternative implementations of the example represented by the diagrams include one or more additional or alternative elements, processes and/or devices. Additionally or alternatively, one or more of the example elements of the diagram may be combined, divided, re-arranged or omitted.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” or “controller” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit or controller include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits or controllers, such as ASICs or FPGAs, are specifically configured hardware for performing operations (e.g., one or more of the operations described herein and represented by the flowcharts of this disclosure, if such are present). Some example logic circuits or controllers are hardware that executes machine-readable instructions to perform operations (e.g., one or more of the operations described herein and represented by the flowcharts of this disclosure, if such are present). Some example logic circuits or controllers include a combination of specifically configured hardware and hardware that executes machine-readable instructions.

The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits or controllers (e.g., ASIC(s)). In some examples the operations described herein are implemented by a combination of specifically designed logic circuit(s) or controller(s) and machine-readable instructions stored on a medium (e.g., a tangible machine-readable medium) for execution by logic circuit(s) or controller(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An apparatus, comprising:
a housing;
a plurality of battery cells disposed within the housing;
a controller disposed within the housing; and
a cell selector disposed within the housing, the cell selector is operatively coupled to the battery cells and the controller, the cell selector operable to configure the battery cells according to a selected cell arrangement from a plurality of possible cell arrangements.

2. The apparatus of claim 1, wherein the cell selector comprises:
a control switch that outputs a control signal based on a state of the control switch, the cell selector selects the selected cell arrangement based on the control signal.

3. The apparatus of claim 2, wherein the control signal is switchable between ground and an output voltage line, the selected cell arrangement corresponding to a first cell arrangement when the control signal is ground and corresponding to a second cell arrangement when the control signal is an output voltage on the output voltage line.

4. The apparatus of claim 2, wherein the cell selector includes a plurality of switches that are responsive to the control signal to configure the plurality of cells in the selected cell arrangement.

5. The apparatus of claim 4, wherein the cell selector includes timing compensation circuitry to control a sequence in which states of the plurality of the switches change in response to the control signal.

6. The apparatus of claim 5, wherein the timing compensation circuitry introduces timing delays to the control signal to control the sequence.

7. The apparatus of claim 2, wherein the control switch is an electro-mechanical switch and the housing includes a resilient member that operatively engages the control switch in response to being depressed.

8. The apparatus of claim 7, wherein the resilient member is integrally formed with the housing by a cantilevered portion of the housing.

9. The apparatus of claim 7, further comprising an arm extending from the resilient member into an interior of the housing, the arm configured to selectively engage the control switch based on an actuation state of the resilient member.

10. The apparatus of claim 8, wherein the resilient member is flush with the housing and includes a portion extending away from the housing from a terminal end of the resilient member, the button portion configured to engage a portion of a device housing of a device when the battery is received by the device housing or to be spaced away from the device housing when the battery is received by the device housing such that the state of the control switch is controlled based on the device that receives the housing.

11. The apparatus of claim 2, wherein the cell selector comprises a plurality of switch devices that are responsive to the state of the control switch.

12. The apparatus of claim 11, wherein, in response to a change in the state of the control switch, a first subset of the plurality of switch device switch to an open state and a second subset of the plurality of switch devices switch to a closed state.

13. The apparatus of claim 11, wherein the cell selector includes timing compensation circuitry that controls a sequence in which at least a subset of the plurality of switch device switch from a first state to a second state.

14. The apparatus of claim 2, wherein the cell selector includes circuitry that comprises:
a first leg, the first leg includes a first battery cell, a second battery cell, and a first transistor,
a negative terminal of the first battery cell is coupled to ground and a positive terminal of the first battery cell is coupled to a negative terminal of the second battery cell,
a positive terminal of the second battery cell is coupled to a drain of the first transitory and a source of the first transistor is coupled to an output voltage line.

15. The apparatus of claim 14, wherein the circuitry of the cell selector further comprises:
a second leg, the second leg includes a second transistor and a third transistor,
a source of the second transistor is coupled to the ground and a drain of the second transistor is coupled to a gate of the first transistor and to a drain of the third transistor,
a source of the third transistor is coupled to the output voltage line,
a gate of the second transistor and a gate of the third transistor are operatively coupled to the control switch.

16. The apparatus of claim 15, wherein the circuitry of the cell selector further comprises:
a third leg, the third leg includes a fourth transistor, a third battery cell, and a fourth battery cell,
a source of the fourth transistor is coupled to the ground and a drain of the fourth transistor is coupled to a negative terminal of the third battery cell,
a gate of the fourth transistor is operatively coupled to the control switch 302,
a positive terminal of the third battery cell is coupled to a negative terminal of the fourth battery cell and a positive terminal of the fourth battery terminal is coupled to the output voltage line,
a drain of the fourth transistor is also coupled to a drain of a fifth transistor and a source of the fifth transistor is coupled to a first node between the drain of the first transistor 330 and the positive terminal of the second battery cell,
a second node between the positive terminal of the first battery cell and the negative terminal of the second battery cell is coupled to the controller 124.

17. The apparatus of claim 16, wherein the circuitry of the cell selector further comprises:
a fourth leg, the fourth leg includes a sixth transistor and a seventh transistor,
a source of the sixth transistor is coupled to the ground and a drain of the sixth transistor is coupled to the gates of an eighth transistor and a ninth transistor and to the drain of the sixth transistor,
a source of the seventh transistor is coupled to the output voltage line,
a gate of the sixth transistor and a gate of the seventh transistor are operatively coupled to the control switch,
a source of the eighth transistor is coupled to a third node between the positive terminal of the third battery cell and the negative terminal of the fourth battery cell and is also coupled to a drain of a tenth transistor,
a gate of the tenth transistor is operatively coupled to the control switch and a source of the tenth transistor is coupled to the controller,
a source of the eighth transistor is coupled to the third node between the positive terminal of the third battery cell and the negative terminal of the fourth battery cell and is also coupled to the drain of the tenth transistor,
a drain of the tenth transistor is coupled to the drain of the ninth transistor and to the controller,
a source of the ninth transistor is coupled to the output voltage line and the output voltage line is also coupled to the controller.

18. The apparatus of claim 1, wherein the selected cell arrangement configures the plurality of battery cells in a series circuit with each other.

19. The apparatus of claim 1, wherein the selected cell arrangement configures at least two of the plurality of battery cells in a parallel circuit with each other.

20. A system, comprising:
an electronic device, the electronic including a battery receiving area; and
a battery pack configured to be received by the electronic device via the battery receiving area,
the battery pack including a housing containing a plurality of battery cells and a cell selector configures the plurality of battery cells in a first cell arrangement in which the battery pack has a first output voltage or a second cell arrangement in which the battery pack has a second output voltage,
the cell selector configured to arrange the battery cells according to the first cell arrangement prior to the battery pack being received by the electronic device via the battery receiving area, and
upon receipt of the battery pack by the electronic device via the battery receiving area, the housing of the battery pack causes the cell selector to switch from the first cell arrangement to the second cell arrangement.

21. The system of claim 20, wherein the electronic device is at least one of a printer or a battery charger.

22. The system of claim 20, wherein the electronic device is the printer and wherein the system further comprises:
a battery charger, and
upon receipt of the battery pack by the battery charger via the battery receiving area, the housing of the battery pack causes the cell selector to remain in the first cell arrangement.

23. A method, comprising:
configuring, by a cell selector of a battery pack, a plurality of battery cells of the battery pack according to a first cell arrangement in which the battery pack has a first output voltage, the battery pack including a housing containing the plurality of battery cells and the cell selector;
receiving the battery pack via a battery receiving area of an electronic device; and
switching, by the cell selector, from the first cell arrangement to the second cell arrangement in which the battery pack outputs a second voltage, the housing of the battery pack causes the cell selector to switch to the second cell arrangement upon receipt of the battery pack by the electronic device via the battery receiving area.
